(19) United States
(12) Patent Application Publication
(10) Pub. No.: US 2022/0136341 A1
(43) Pub. Date: May 5, 2022

(54) COATING COMPOSITIONS FOR EROSION MITIGATION, AND COATED COMPONENTS AND METHODS USING SAID COATINGS

(71) Applicant: Chevron U.S.A. Inc., San Ramon, CA (US)

(72) Inventors: Lee David Rhyne, Cypress, TX (US); Kimberly Ann Fernandez Hoyle, Houston, TX (US); Robert Ernest Rettew, Berkeley, CA (US); Benjamin M. Chaloner-Gill, Alameda, CA (US); Peter F. Crowder, Houston, TX (US)

(21) Appl. No.: 17/430,292

(22) PCT Filed: Feb. 13, 2020
(86) PCT No.: PCT/US2020/018155

§ 371 Date: Aug. 11, 2021

Related U.S. Application Data
(60) Provisional application No. 62/804,877, filed on Feb. 13, 2019.

(51) Int. Cl. E21B 17/10; E21B 41/02; B05D 7/00; B05D 7/22; C09D 5/08; C09D 5/00; C09D 119/00

(52) U.S. Cl. CPC E21B 17/1085; E21B 41/02; E21B 17/1007; C09D 119/00; B05D 7/225; C09D 5/08; C09D 5/002; B05D 7/542

(57) ABSTRACT

A coated pipe to transmit produced fluids in a system configured to recover hydrocarbons from a subterranean formation may include a pipe component configured to transmit the produced fluids and having an internal surface defining an inner diameter of the pipe component; and a coating deposited on the internal surface of the pipe component and configured to extend the life of the pipe component by mitigating erosion caused by the produced fluids during transmission thereof.

### FIELD

The present disclosure relates generally to the field of coating compositions for forming erosion-resistant coatings on coated articles. The present disclosure further relates to piping and pressure containment components coated by such coatings.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Currently in the oil and gas and other industries, in piping components used for transmitting fluids, e.g., production fluids that include oil, water and gas, interior surfaces of the piping components can be exposed to erodents such as fines and sand carried with the production fluids. Over time, the presence of the fines and sand can erode the internal pipe walls of the piping components. This erosion results in the piping needing costly replacement to avoid the potential of developing a crack or weakened wall that could lead to a leak.

In some instances, this problem has been addressed by using higher pipe wall thickness. However, this approach can be cost-prohibitive when considering the relatively large size of such pipes and the extent of possible erosion damage over the expected lifetime of the piping components. Anti-erosion, ceramic coatings such as tungsten-carbide, silicon-carbide, or iron boride are also options to address erosion. Such coatings may be applied via chemical-vapor deposition (CVD) or other high temperature, high energy processes. In the environments encountered in the transmission of production fluids, these coatings have been found to be brittle under flexure of the pipe caused by normal operations such as sending instruments through the piping (e.g., logging tools, pigging) and during installation of the piping components. These coatings are also easily damaged when subjected to thermal cycling due to the difference in thermal expansion of the ceramic and the base metal of the pipe, which can result in cracking of the coating and debonding from the base metal or other material thereby severely reducing its efficacy.

There exists a need for a cost-effective, practical solution for use with piping systems used for transmitting fluids that overcomes the aforementioned problems.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

An embodiment of a coating composition for mitigating erosion in coated articles in accordance with this disclosure may include a polymeric matrix, and a plurality of hard particles dispersed in the polymeric matrix. The plurality of hard particles has a particle size (e.g., D₅₀) in the range from 1 μm to 500 μm, and is present in the polymeric matrix at a ratio of from 0.5:1 to 20:1 by weight.

An embodiment of a coated article in accordance with this disclosure may include an article, and the coating composition described above applied to a surface of the article.

An embodiment of a coated article in accordance with this disclosure may have a coating for mitigating erosion of the coating. The coating includes a polymeric layer bonded to the article surface and a hard protective layer that includes a plurality of hard particles bonded to the polymeric layer for protecting the polymeric layer from erosion.

An embodiment of a method for coating an article in accordance with this disclosure includes forming a mixture of a polymeric matrix material and a plurality of hard particles dispersed in the polymeric matrix material, the plurality of hard particles having a particle size in the range from 1 to 500 μm and being present in the polymeric matrix material at a ratio of 0.5:1 to 20:1 by weight. The mixture is applied to the article surface to form a coating on the article surface.

An embodiment of a method for coating an article in accordance with this disclosure includes forming a polymeric layer on the article surface, and forming a hard protective layer of a plurality of hard particles on and bonded to the polymeric layer for protecting the polymeric layer from erosion.

An embodiment of a coated pipe in accordance with this disclosure is used to transmit produced fluids in a system configured to recover hydrocarbons from a subterranean formation. The coated pipe may include a pipe component configured to transmit the produced fluids and having an internal surface defining an inner diameter of the pipe component. A coating of the coated pipe is deposited on the internal surface of the pipe component and is configured to extend the life of the pipe component by mitigating erosion caused by the produced fluids during transmission thereof. The coating includes a plurality of particles dispersed in a polymeric matrix material, and the plurality of particles has a Mohs hardness equal to or greater than a Mohs hardness of expected erodent materials contained within the produced fluids. The polymeric matrix material has a Shore A hardness between 30 and 100 or a Shore D hardness between 0 and 90, such as a hardness between 30 Shore A and 90 Shore D.

An embodiment of a method for producing a coated pipe to transmit produced fluids in a system configured to recover hydrocarbons from a subterranean formation may include selecting a plurality of particles based on a composition of the produced fluids, and based on an expected velocity of transmission of the produced fluids within the coated pipe. The method may also include selecting a polymeric matrix material based on the composition of the produced fluids, and based on the expected velocity of transmission of the produced fluids within the coated pipe; dispersing the plurality of particles within the polymeric matrix material to form a mixture; and applying the mixture to a surface of a pipe or a polymer layer bonded to a surface of the pipe to form a coating on the surface of the pipe.

An embodiment of a coated pipe in accordance with this disclosure may be used to transmit produced fluids in a system configured to recover hydrocarbons from a subterranean formation. In such an embodiment, the coated pipe may include a polymeric layer having a polymer layered on a surface of a pipe. The polymeric layer has a hardness between 30 Shore A and 90 Shore D. A protective layer of the coated pipe includes a plurality of particles. The plurality of particles has a Mohs hardness equal to or greater than a Mohs hardness of expected erodent materials contained within the produced fluids.

### BRIEF DESCRIPTION OF THE DRAWINGS

These and other objects, features and advantages of the present invention will become better understood with reference to the following description, appended claims and accompanying drawings. The drawings are not considered limiting of the scope of the appended claims. Reference numerals designate like or corresponding, but not necessarily identical, elements. The drawings illustrate only example embodiments. The elements and features shown in the drawings are not necessarily to scale, emphasis instead being placed upon clearly illustrating the principles of the example embodiments. Additionally, certain dimensions or positionings may be exaggerated to help visually convey such principles.

FIG. 1 illustrates a surface of a piping component coated with an exemplary coating.

FIG. 2 illustrates a surface of a piping component coated with another exemplary coating.

FIG. 3 illustrates a surface of a piping component coated with yet another exemplary coating.

FIG. 4 is a chart of erosion data obtained for various example coated steel coupons and demonstrating the efficacy of coatings configured in accordance with present embodiments.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As set forth above, certain components used in systems that recover hydrocarbons in subterranean formations may be subject to relatively high rates of erosion. These high rates of erosion may be due to a variety of factors. One factor may include the composition of the materials extracted from the subterranean formation and the fluids used to facilitate this extraction. The combination fluids that are transmitted by such components may be referred to as produced fluids, and the particular composition of the produced fluids will generally differ from formation to formation. Common erodents in produced fluids include sand (e.g., silicates) and/or fracking materials (also including sand) that range from sub-micron particles to several millimeters in diameter. For example, high rates of erosion leading to as much as a 50% reduction in pipe wall thickness in less than 6 months have been observed from a mixture of sand (sub-100 micron diameter) and frack sand (300 micron diameter). As another example, production fluids may sometimes include highly abrasive diatomaceous earth (sub-10 micron diameter) with frack sand (600 micron diameter). In other operations, such as during drilling or shutting in of a well, fluids such as weighted mud may be used. Materials used to weight the mud may include calcium carbonate, barite (barium sulfate), and hematite (iron oxide, Fe₂O₃), and these cause erosion to varying degrees depending on particle hardness and velocity.

In this respect, another factor that can lead to high rates of erosion is the velocity of transmission of produced fluids through the pipe. Transmission velocities may vary by the size of the pipe (e.g., its internal diameter), the nature of the fluids transmitted (e.g., gas-dominated versus liquid-dominated flows), and the presence of equipment that may result in pressure changes (e.g., choke valves). As an example, in gas-dominated flows, maximum design velocities may range from 30 m/s to 100 m/s (e.g., inside and just downstream of a choke). Due to high velocities and low density/viscosity associated with the carrier fluid, the gas dominated flows typically see higher erosion rates than liquid dominated streams. Liquid dominated streams may operate under a variety of conditions, as one non-limiting example, as high as 5 m/s for liquid superficial velocity and 10 m/s for gas superficial velocity. Much higher velocities may be present in certain sections of piping, for example an elbow section of pipe that is on the downstream side of a choke valve that handles very large pressure drops. Such large pressure drops can cause the fluid velocity to approach or even exceed sonic velocity.

To address the effects of erosion on the pipes associated with these types of systems, it is now recognized that it may be desirable to coat the pipes with a coating that is able to withstand the conditions under which such systems operate. For instance, it is now recognized that an appropriately designed coating may include a hard particulate component and a softer polymeric component. The softer polymeric component is generally configured to dissipate energy resulting from impacts to the coating by erodent materials of the produced fluids. On the other hand, the particulate component, which is much harder, may reduce the loss of coating material from the pipe by reducing cutting and impact wear. As a non-limiting example, the particulate component may include a plurality of particles having a hardness that is at least as hard as the expected erodent materials in the produced fluids, and a particle size (e.g., a particle size distribution D₅₀) that is on the same order as the expected erodent materials in the produced fluids. The particulate component may be dispersed within the polymer component, or may be layered with the polymer component, or both. Further details relating to such embodiments are described in further detail below.

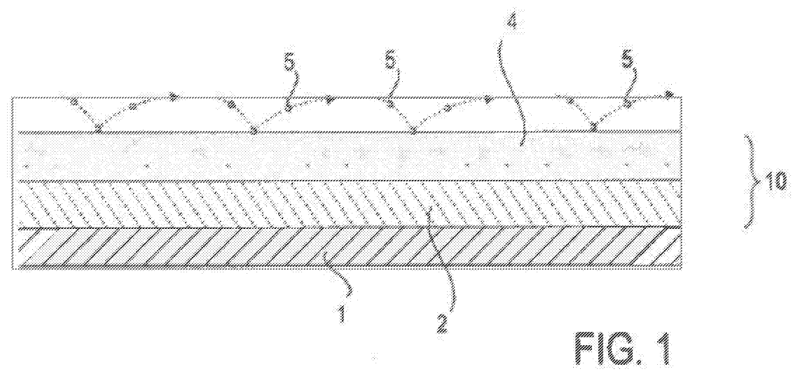

Referring to FIG. 1, shown is an embodiment of an article 1 having a coated surface. The article 1 can be any of a number of components of a system used for extracting hydrocarbons from a subterranean formation. By way of example, the article 1 may include, but is not limited to, sections of pipe, pipe fittings (such as elbows, tees, contractions, expansions, etc.), valve and choke internals, separator momentum breakers, and the like. The article 1 can also be a pressure containment component such as a wellhead component, fittings, flanges, and the like. For convenience, “article,” “piping component,” and “pressure containment component” are used herein interchangeably to refer to the article to be coated. The article 1, and the article surface, can be made from a variety of materials. For instance, the article surface can include carbon steel, corrosion resistant alloy, titanium, a plastic, an epoxy-fiber composite and/or aluminum.

In one embodiment, a coating composition is provided that can form a coating 10 capable of protecting the surface of the piping component 1 from erosion caused by particulate material, e.g., fines or sand, also referred to herein as “erodents,” “erodent materials” or “erosive particles.” The coating 10 can be applied to an internal and/or external piping surface of the article 1, referred to for the purpose of the present discussion as a piping component 1. The coating 10 can be tightly bound, e.g., physically and/or chemically, to the piping component 1 such that the coating 10 adheres to the surface of the piping component 1.

During use of the piping component 1, erodents 5 can be flowing in fluids (produced fluids) within the piping component 1. As set forth above, the erosive particles 5 anticipated to be encountered in fluids during use of the piping component 1 can be in a range of particle sizes from a few micrometers up to several millimeters in diameter. In one embodiment and by way of a more specific but non-limiting example, the erosive particles 5 can be in a range of particle sizes from about 10 micron to about 450 micron diameter. Particle sizes, as noted above, may range from sub-micron to millimeter range, depending for example on the reservoir and conditions. Sand screens may be present to keep the erodent particle sizes on the order of about 40 micron and below. However, when sand screens erode and fail, a wide range of erodent particle sizes may occur.

In the embodiment shown in FIG. 1, the coating 10 on the surface of the piping component 1 includes a polymeric layer 2 layered on (e.g., chemically bonded to, or physically but not chemically bonded to) the surface of the piping component 1. Hard particles that make up a hard protective layer 4 are bonded to the polymeric layer 2 for protecting the polymeric layer 2 from damage such as cutting and scratching by the erosive particles 5. For instance, erodents may strike the coating 10 in a manner that would otherwise cut or scratch away the polymeric layer 2. The hard protective layer 4 is configured to mitigate such wear.

By way of non-limiting example, the polymer of the polymeric layer 2 for bonding to the surface of the piping component 1 can be a viscoelastic polymer, an elastomer, a fluorinated polymer, a partially fluorinated polymer, a rubber, and combinations thereof. The elastomer can be a silicone, a polyurethane, a natural or artificial rubber (e.g., a urethane rubber or a nitrile rubber), a fluoroelastomer, and combinations thereof. The partially fluorinated polymer can be polyvinylidene fluoride. In an alternative embodiment, the polymer may be polyether ether ketone.

The polymeric layer 2 dissipates energy caused by impacts to the coating 10. The polymer of layer 2 can be selected for any of a number of factors, including, but not limited to, bond strength to the surface of the piping component or to an optional adhesive layer on the surface of the piping component, bond strength to the hard protective layer 4, chemical compatibility with the article surface or the hard particles, viscoelastic spring properties, environmental compatibility, chemical resistance, impact absorption, and ease of handling and application. By way of non-limiting example, it is presently recognized that it may be desirable for the polymeric layer 2 to have a Shore A hardness between 30 and 100 or a Shore D hardness between 0 and 90, such as a hardness between 30 Shore A and 90 Shore D, to allow for effective dissipation of imparted impact energy by erodents within produced fluids. As noted, softer (lower) Shore A/Shore D hardness values may be desirable since, in some instances, they have been found to be more effective at mitigating erosion than their harder counterparts (higher on the Shore A/Shore D scales).

By way of further non-limiting example, for embodiments in which the piping component 1 is used to transmit produced fluids in a system configured to recover hydrocarbons from a subterranean formation, it may be desirable for the polymeric layer 2 to be chemically resistant to a variety of materials. For instance, the polymeric layer 2, and thus the polymer thereof, may be resistant to cross-linking due to H₂S amounts of up to 20 mol % in the produced fluids stream, chemically resistant to hydrolysis due to CO₂ amounts of up to 30 mol % in the produced fluids stream, and may be compatible with hydrocarbons (e.g., crude oil, natural gas) and additives and other fluids used in the system to recover hydrocarbons. Such additives and other fluids may include brines, corrosion inhibitors, hydrate inhibitors, defoamers, demulsifiers, and so forth. It is presently recognized that nitrile rubbers may, in certain embodiments, be particularly desirable for such applications.

In one embodiment, the hard particles that make up the hard protective layer 4 for protecting the polymeric layer 2 from damage can be any particulate material with a hardness equal to or harder than the erodent. Such particles may include but are not limited to sand particles, silicon oxide particles, silicon carbide particles, silicon aluminum nitride particles, tungsten carbide particles, boron nitride particles steel particles, aluminum oxide particles, titanium carbide particles, diamond particles, carbon nanotubes, metal nitrides, and combinations thereof. In one embodiment, the hard particles have a Mohs hardness greater than 7, such as between 7 and 10. In one embodiment, the hard particles by design have a Mohs hardness equal to or greater than the Mohs hardness of an expected erodent 5. In certain embodiments, the plurality of hard particles has a particle size (e.g., a particle size distribution D₅₀) that is within 50%, or equal to or greater than an expected particle size distribution D₅₀ of the expected erodent materials contained within the produced fluids, such as a D₅₀ in the range from 10 μm to 500 μm.

In one embodiment, a method for forming the coating 10 on the article surface includes forming the polymeric layer 2 on the article surface 1. In one embodiment, the polymeric layer 2 is applied to the article surface by a suitable technique. Non-limiting examples of suitable techniques include dipping, vapor deposition, melt deposition, spraying, extrusion, powder melting or combinations thereof. The hard protective layer 4 is then formed on the polymeric layer 2 by attaching the hard particles to the polymeric layer. This can be done by dusting, spraying or other means of conveying, such as by pneumatic conveying, the particles to the surface of the polymeric layer. The polymeric layer can attach to the particles via bonding groups such as halides, hydroxyl groups (OH), Si(OR)₃ compounds, primary or secondary amines, amino heterocycles, or by being incorporated in the uncured polymeric layer.

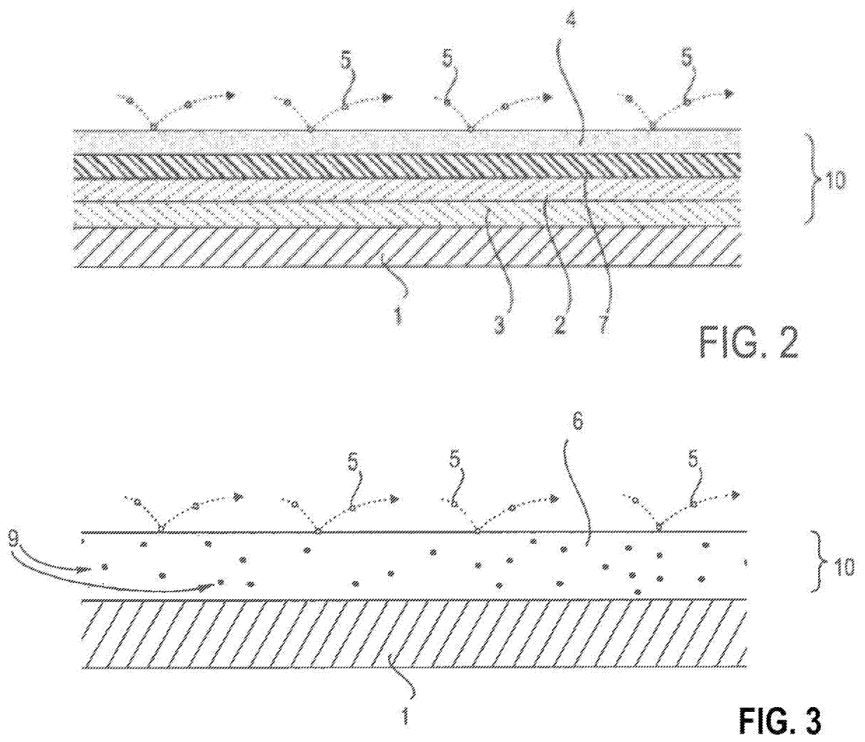

In one embodiment, as shown in FIG. 2, an optional adhesive layer 3 is formed on the article surface prior to applying the mixture to the article surface to bind the polymeric layer 2 to the surface of the piping component 1. The optional adhesive layer 3 can contain an epoxy or primer applied to the article surface prior to applying the polymeric layer 2 to the article surface.

In one embodiment, an optional linking layer 7 is present to bind the polymeric layer 2 to the hard particles of the hard protective layer 4. In one embodiment, the optional linking layer 7 can contain a silane coupling agent (e.g., a mono- or di- or tri-chloro-silane) or the like. Silanes are saturated chemical compounds having one or more silicon atoms linked to each other or one or more atoms of other chemical elements as the tetrahedral centers of multiple single bonds. Silane coupling agents contain functional groups that bond with both organic materials and inorganic materials so that they can link organic materials to inorganic materials. Nonlimiting examples of suitable silane coupling agents are silane coupling agents available from Shin-Etsu Chemical Co., Ltd., Tokyo, Japan. The particular agent used for the optional linking layer 7 is dependent on the polymer of the polymeric layer 2. For instance, some rubbers do not adhere well to sand while other rubbers do; so that in one embodiment, a linking layer 7 is used.

In one embodiment, the polymer of the polymeric layer 2 primarily contains a silicone elastomer having a chemical formula: (—O—SiO₂—O)ₙ that is functionalized on each end of the polymer.

In one embodiment, the polymer of the polymeric layer 2 can be provided with a first functionalized end for chemical bonding to the surface of the piping component 1. In one embodiment, the first functionalized end can be an imidazoline structure having a chemical formula: C₃H₆N₂. Other suitable examples of the first functionalized end are halides, hydroxyl groups (OH), Si(OR)₃ compounds, primary or secondary amines, and amino heterocycles.

In one embodiment, the polymer of the polymeric layer 2 can be provided with a second functionalized end for bonding the polymer to the plurality of hard particles. The second functionalized end can be a silane coupling agent and/or a Si(OR)₃. Multiple chemical bonds can be present between the polymer layer 2 and each of the plurality of hard particles.

In one embodiment, the linking layer 7 can be formed from a trichlorosilane group having a chemical formula: —SiCl₃. The upper surface of the elastomeric polymer of the polymeric layer 2 can be functionalized with the trichlorosilane group. This group can then chemically react and bind with the hard protective layer 4. In one embodiment, the trichlorosilane group can be reacted with particles that make up a hard protective layer 4 having a diameter (e.g., a D₅₀) in a range of from 20 μm to 150 μm as the hard particles. Thus, multiple chemical bonds can form with each particle. Without wishing to be bound by theory, since the particles that make up a hard protective layer 4 are on the same order of magnitude or greater in terms of size as the erosive particles 5, the energy of an impact on the coating 10 by erosive particles 5 is expected to be transferred to the bound hard particles and in turn into the polymeric layer 2 in accordance with the law of conservation of momentum as supported by Newton's laws of motion. The transfer of energy of impact protects the coating 10 from erosion by the erosive particles 5. The polymeric layer 2 dissipates the impact energy once it is transferred to the polymeric layer 2.

In one embodiment, additional optional layers can be provided in the coating 10. For instance, in one embodiment, a stiffer viscoelastic material can underlay a softer viscoelastomer layer 2. In one embodiment, a chemically resistive layer to prevent corrosion can be used as one of the multiple layers of the coating 10.

In view of the foregoing, it should be appreciated that certain embodiments of methods for producing a coated pipe to transmit produced fluids in a system configured to recover hydrocarbons from a subterranean formation, for example to produce the embodiments described with respect to FIGS. 1 and 2, may include selecting a plurality of particles for a coating based on a composition of the produced fluids, and based on an expected velocity of transmission of the produced fluids within the coated pipe. A polymer for the coating may be selected based on the composition of the produced fluids, and based on the expected velocity of transmission of the produced fluids within the coated pipe. A polymeric layer having the polymer may be formed on a surface of a pipe, formed on an adhesive layer bonded to the surface of the pipe. A protective layer comprising the plurality of particles may then be formed on the polymeric layer.

As set forth above, selection of the components of the coating 10 may be based on a number of factors. The compositional aspects of the produced fluids that may be considered as part of selecting the plurality of particles in accordance with such methods may include the chemical composition of expected erodent materials in the produced fluids, the hardness of the expected erodent materials, the particle size (e.g., particle size distribution) of the expected erodent materials, and so forth. The plurality of particles may also be selected so as to be chemically compatible with other components of the produced fluids, such as brine, hydrocarbons, acidic compounds, and so forth. The plurality of particles may also be selected for compatibility with other fluids used to facilitate hydrocarbon production, as previously noted.

Selecting the polymer for the coating based on the composition of the produced fluids, and based on the expected velocity of transmission of the produced fluids within the coated pipe may involve selecting the polymer for chemical stability in a particular application, such as based on expected concentrations of hydrogen sulfide and carbon dioxide within produced fluids. By way of non-limiting example, the expected concentrations of hydrogen sulfide and carbon dioxide may be at levels that would cause unwanted side reactions within the polymer, such as unwanted cross-linking or hydrolysis which could degrade the polymer or cause it to lose its ability to dissipate energy from impact forces. Further, as with the plurality of particles, the polymer may be selected for its chemical compatibility with various fluids used to facilitate hydrocarbon production.

In addition to or as an alternative to the embodiments set forth above, as shown in FIG. 3, an embodiment of the coating 10 on the surface of the piping component 1 may be a single polymeric layer 6 having hard particles 9 bonded to (e.g., physically, chemically) and dispersed throughout the polymeric layer 6. As in the embodiment shown in FIG. 1 and discussed previously, the polymer of the polymeric layer 6 is a material that bonds (e.g., chemically bonds, or physically bonds but does not chemically bond) to the surface of the piping component 1, and dissipates energy caused by impacts to the coating 10. In one embodiment, the polymer of the polymeric layer 6 can be a viscoelastic polymer, an elastomer, a fluorinated polymer, a partially fluorinated polymer, a rubber, and combinations thereof. The elastomer can be a silicone, a polyurethane, a natural or artificial rubber (e.g., a urethane rubber, a nitrile rubber), a fluoroelastomer, and combinations thereof. The partially fluorinated polymer can be polyvinylidene fluoride. In an alternative embodiment, the polymer may be polyether ether ketone.

The protective hard particles 9 are interspersed within the matrix of the polymeric material. The hard particles 9 within the polymeric layer 6 can be selected from the hard particles listed above with reference to the embodiment shown in FIG. 1 and discussed previously. In one embodiment, the hard particles 9 can be any particulate material with a hardness (e.g., Mohs hardness) equal to or harder than the erodent, including but not limited to sand particles, silicon oxide particles, silicon carbide particles, tungsten carbide particles, steel particles, aluminum oxide particles, titanium carbide particles, silicon aluminum nitride particles, boron nitride particles, diamond particles, carbon nanotubes, metal nitrides, and combinations thereof. In one embodiment, the hard particles 9 have a Mohs hardness greater than 7, such as between 7 and 10. In one embodiment, the hard particles 9 by design have a Mohs hardness equal to or greater than the Mohs hardness of an expected erodent 5 (e.g., a component of a produced fluid).

In one embodiment, a method for forming the coating 10 on the article surface includes forming a mixture of the polymer and the hard particles to form a dispersion of the hard particles in the polymeric matrix material. The mixture is formed so that the hard particles are present in the polymeric matrix material at a ratio of from 0.5:1 by weight particles to polymeric matrix material to 20:1 by weight particles to polymeric matrix material. The mixture is then applied to the article surface to form the coating 10 on the article surface. In one embodiment, the mixture is applied to the article surface by a suitable technique. Suitable techniques include dipping, vapor deposition, melt deposition, spraying, extrusion, powder melting or combinations thereof.

This embodiment provides a renewable hard surface in the event that the surface of the coating 10 becomes damaged. In the event of erosion damage to the surface of the coating 10, the newly exposed surface will include hard particles 9 exposed by the erosive damage.

The exact chemistries of the polymer and the hard particles 9 in the polymeric layer 6 can be varied depending on the specific fluids being transported in the piping components 1. These variations may include changes to the size and/or distribution of the hard particles 9 or the type of the hard particles 9. A pattern of how the particles 9 are dispersed within the coating 10 can be varied to suit the varying need for protection on the article 1. By way of non-limiting example, certain embodiments of the coating 10 may include a gradient of the hard particles 9 within the polymeric layer 6, such that more of the hard particles 9 are present closer to an exposed surface of the coating 10 compared to the interface between the coating 10 and the surface of the piping component 1.

Further, combinations of aspects of the embodiments set forth in FIGS. 1-3 may be combined, for instance to facilitate bonding of the mixture of the particles and matrix to the surface of the article 1. For example, in one embodiment, the plurality of particles and the polymeric matrix material form a first layer of the coating 10. The coating 10 may also include a second layer positioned between the first layer and the article surface of the article 1 (e.g., an internal surface of a piping component). The second layer of the coating 10 may include a polymer material having a greater bonding strength to a material of the article surface of the article 1 (e.g., the internal surface of the piping component) than a bonding strength of the polymeric matrix material of the first layer to the material of the interior surface of the pipe component.

In one embodiment, the polymer in the polymeric layer 6 in FIG. 1 or the polymeric layer 6 in FIG. 3 is formed from a cross-linkable polymer. Altering the amount of cross-linking, e.g., by varying the molecular structure of cross-links and the degree of cross-linking, changes the response time of the polymer to dissipate the impact energy. In one embodiment, the polymer contains polymeric cross-links at a density corresponding to the optimized hardness and elasticity for the impacting erodent particles. This may be achieved through selection of different molecular weights of the polymer feedstock, functionalization of the polymer molecule, or variations in the cross-linking techniques and curing chemicals employed. Such techniques as known to one of ordinary skill in the art can be used to tune the response of the overall coating to the fluid flow system, the desired viscoelastic properties of the coating 10, and the expected erosive particles 5. The degree of cross-linking can be tuned to achieve a desired property of the coating. For example, non-limiting examples of desired properties include hardness, swelling, bond strength to an adjacent surface, chemical compatibility with an adjacent surface, chemical compatibility with the plurality of hard particles, a viscoelastic spring property, an environmental property, chemical resistance, impact absorption, viscosity, ease of handling and application, and combinations thereof.

In accordance with certain of these embodiments, one embodiment of a method for producing a coated pipe, for example to transmit produced fluids in a system configured to recover hydrocarbons from a subterranean formation in accordance with the embodiment of FIG. 3 may include selecting a plurality of particles based on a composition of the produced fluids, and based on an expected velocity of transmission of the produced fluids within the coated pipe. A polymeric matrix material may be selected based on the composition of the produced fluids, and based on the expected velocity of transmission of the produced fluids within the coated pipe. The plurality of particles may be dispersed within the polymeric matrix material to form a mixture, and the mixture applied to a surface of a pipe or a polymer layer bonded to a surface of the pipe to form a coating on the surface of the pipe. Applying the mixture may include using a technique selected from the group consisting of dipping, vapor deposition, melt deposition, spraying, extrusion, powder melting and combinations thereof, as previously noted.

Coated articles using embodiments herein are not limited to the oil field, but could be used in other industries such as the pneumatic conveying of cement materials as one non-limiting example.

### EXAMPLES

### Examples 1 and 2

A flat steel bar having a thickness of 5 mm and a width of 19 mm was cut into several pieces about 85 mm long. These pieces were surface prepared to form test coupons by grinding them with a fine grinding wheel until all surfaces were shiny and showed grinding marks.

One of the pieces was coated with a silicone rubber and one of the pieces was coated with a urethane rubber to form comparative test coupons.

### Test Procedure

Testing involved cutting away a portion (about 20 mm) of the coating, drilling two holes in the coupon, and mounting the coupon firmly in a coupon holder. The coupon was oriented to face an incoming flow of air and silicon carbide erodent particles in a four inch diameter flow loop with steel elbows a distance of greater than 40 inches upstream and downstream of the test coupon. The test coupons were subjected to the flow of air containing silicon carbide particles as erodent particles in a 4-inch test loop. The silicon carbide particles had an average particle diameter of 22.8 μm. The air flow rate at the coupons was 40 m/s at 0.25 barg at a temperature of 37° C. Silicon carbide particles were injected into the air at 10 kg/hr. The erodent particles impacted the entire coupon evenly.

### Example 1

Parts A and B of a commercially available platinum catalyzed silicone rubber was treated with vacuum for 5 minutes. Equal parts by weight (75 grams each) were mixed by hand and treated with vacuum for 1 minute to remove bubbles. The mixture was then poured over a test coupon with excess allowed to run off. Silicon carbide grit was then sprinkled across the surface of the liquid silicone rubber. The silicon carbide was slightly wetted by the liquid silicone rubber. The coupon was allowed to cure overnight. Excess silicon carbide was brushed off the silicone rubber manually. The excess silicone rubber was cut such that the steel coupon remained coated on the flat surface as well as the edges. The coupon was tested using the test procedure about one week later. After 2 hours of test exposure, the coupon was removed. Evidence was observed of the silicone rubber becoming unbonded from the steel in two separate pieces at two points in time, since the steel was eroded more in one region and less in the other region. In other words, one region was eroded more because it spent more time directly exposed to erodent particles.

### Example 2

Parts A and B of a commercially available urethane was treated with vacuum for 5 minutes. Equal parts by weight (75 grams each) were mixed by hand and treated with vacuum for 1 minute to remove bubbles. The mixture was then poured over the steel coupon with excess allowed to run off. Silicon carbide grit was then sprinkled across the surface of the liquid urethane rubber. The silicon carbide was immediately wetted by the liquid urethane rubber and pulled into the liquid. A significant amount of the silicon carbide grit was added (about 1:1 with respect to the liquid urethane by volume) and all of the silicon carbide was wetted and pulled into the liquid. The coupon was allowed to cure overnight. Very little excess silicon carbide was manually brushed off the cured urethane rubber. The excess urethane rubber was cut such that the steel coupon remained coated on the flat surface as well as the edges. The coupon was tested about one week later. The initial coupon weight was 54.457 grams. After 2 hours of test exposure, the coupon was removed. The coupon was then weighed and a weight loss of 13 mg was observed. It is believed the weight loss was due to excess silicon carbide on the surface being removed. No evidence of erosion was noted.

The test coupon exposed area was about 1235 mm² ((85-20)*19). At 1 μm metal loss per kg of sand, a bare steel coupon would therefore be expected to lose about 1.235 mm³ per kg of sand. About 20 kg of sand passed by the coupon during the test (2 hours*10 kg/hr). Thus, it is expected that the bare metal would have lost 20*1.235, or 24.7 mm³. Using the density of steel (8000 kg/m³ or 8 mg/mm³), the calculated metal loss would be 8 mg/mm³*24.7 mm³=198 mg. The total weight loss of the coupon 13 mg observed in Example 2 as compared to an expected bare steel coupon weight loss of 198 mg indicates the bare steel would have lost 15 times more weight than the coated coupon of Example 2.

The steel elbows in the test rig had about 1.0-1.2 μm (about 0.001-0.0012 mm) of steel loss per kg of sand in both Examples 1 and 2.

### Examples 3-9

### Test Procedure

Erosion testing was performed for various materials and therefore mechanical properties that performed best in this application. ASTM G76 involves the application of a jet of erosive material under particular conditions, with the nozzle oriented at a 90-degree angle with respect to the surface to be tested. Thus, the erosion testing performed for Examples 3-9 provides data that primarily relates to the ability of a coating to mitigate impact wear, although it is believed that overall erosion mitigation trends may be gleaned from this data. ASTM G76 was modified to increase the amount of wear in a given test and ease the fabrication of the testing apparatus. Modifications to ASTM G76 for Examples 3-9 were: (1.) Nozzle size: 1.5 mm (per ASTM) was changed to 9 mm; (2.) Velocity: 30 m/s (per ASTM) was changed to 55 m/s; (3.) Particle Type:50 μm Al₂O₃ (per ASTM) was changed to 150 μm sand; (4.) Particle Feed Rate: 2 g/min (per ASTM) was changed to 15 g/min; and (5.) Testing duration: 10 min (per ASTM) was changed to two 2 hr-rounds for a total of 4 hours.

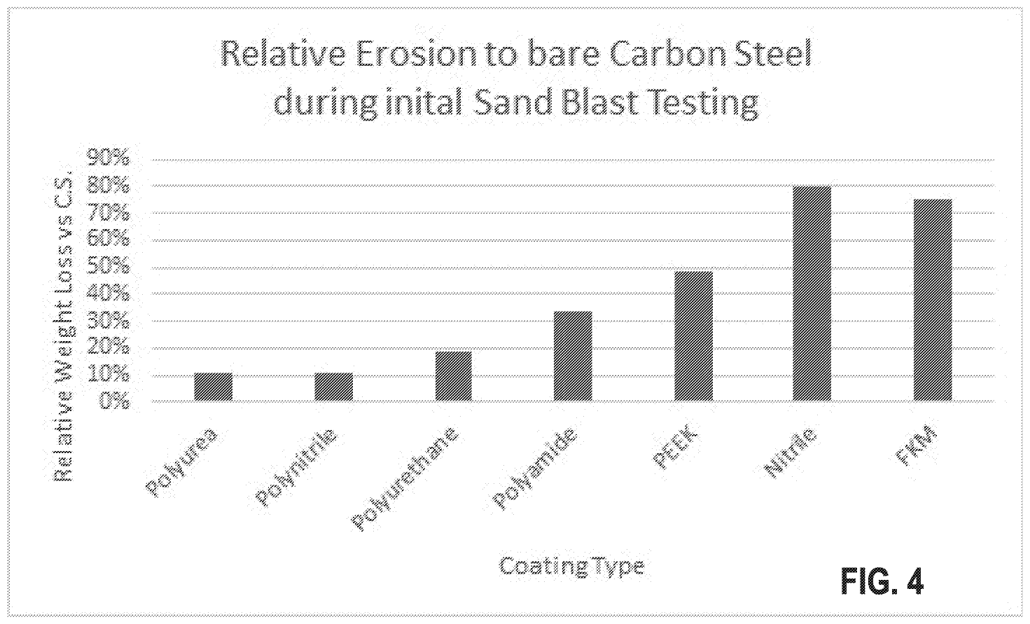

Carbon steel coupons were prepared and coated with a variety of coatings that had no particulate loading, which is referenced in the results shown in FIG. 4 as “control,” as well as coatings having a loading of 60% by weight SiC. Triplicate tests on each coating with 60% SiC and without SiC were performed for a 2 hr duration. After these tests were reviewed, an additional 2 hrs of testing was performed on all but a two-component fluoroelastomer coating due to its poor performance in the 2 hr test. A summary of these results is shown in FIG. 4. Note that although there are error bars present in each of the results shown in FIG. 4, because the error bars are approximately the same across the results, and to facilitate discussion, these results are discussed below without reference to such error bars. However, it should be recognized that each of the results shown in FIG. 4 represents a range when the errors are taken into consideration.

To compare the coatings, as shown in FIG. 4, a blank carbon steel coupon was used for comparative and control purposes, and material losses are shown as percentage loss compared to the bare carbon steel coupon. Higher performing coatings show a smaller percentage loss versus carbon steel.

Various properties of these coatings are also noted and were measured in accordance with appropriate standardized measurement techniques. For example, porosity and SiC powder dispersion tests were conducted according to CSA Z245.20-14, Section 12.10. Samples were cooled to at least −30° C./−22° F. for 1 hour and then bent backwards to remove the coating from the substrate. If coating chips were unable to be removed from the steel substrate, multiple parallel scribes were cut into the coating down to the substrate, and then a blade was inserted beneath coating in order to lift ships by pressure. The porosity was examined microscopically (40×) and rated according to the standard, meanwhile the SiC dispersion was examined for uniformity. Scanning electron microscopy (SEM) and energy dispersive X-ray analysis (EDX) was performed by GR Petrology in Calgary. An Oxford INCA microanalysis system attached to a JEOL JSM-6610 scanning electron microscope was used. Shore A and D Hardness were measured according to ASTM D2240.

### Example 3

A commercially available two-component polyurea coating, shown in FIG. 4 as “polyurea,” was mixed with up to 60% SiC powder. The resulting coating with SiC particles had a Shore D hardness between 53 and 62. Mixing of the two-component polyurea with SiC was achieved when parts A, B of the polyurea and SiC powder were mixed at the same time. The application was conducted by using a foam brush and resulted in an even distribution of SiC particles in coating film, uniform DFT and low porosity, as indicated by visual, optical microscopic and SEM/EDX examinations. As shown in FIG. 4, the polyurea with 60% SiC showed a material weight loss of 10% of the material loss of the carbon steel blank.

### Example 4

A commercially available single component nitrile adhesive, shown in FIG. 4 as “polynitrile,” was mixed with up to 60% SiC powder. The resulting coating with SiC particles had a Shore D hardness between 49 and 59. The mixing procedure of the polynitrile with SiC was achieved by mixing the liquid adhesive with SiC powder. Due to the high viscosity of this adhesive, different application procedures were conducted such as pouring/leveling, brush and dipping. The pouring/leveling application resulted in even distribution of SiC particles in adhesive film, uniform DFT, but numerous trapped air bubbles as indicated by visual, optical microscopic and SEM/EDX examinations. The brush application was found to reduce the size of trapped air bubble but resulted in low DFT. The dipping application was found to reduce the number of trapped air bubble in coating but resulted in uneven DFT. The adhesive with and without SiC showed excellent adhesion to the steel substrate. As shown in FIG. 4, the polynitrile with 60% SiC showed a material weight loss of about 10% of the material weight loss of the carbon steel blank.

### Example 5

A commercially available liquid two-component urethane rubber, shown in FIG. 4 as “polyurethane,” was mixed with 60% SiC powder. The coating with SiC particles had a resulting Shore A hardness between 70 and 82. The mixing procedure of the polyurethane with SiC was performed by mixing parts A and B of the polyurethane initially followed by the addition of SiC powder. The application was conducted using a foam brush and resulted in an even distribution of SiC particles, uniform DFT and low porosity, as indicated by visual, optical microscopic and SEM/EDX examinations. The polyurethane with and without SiC showed poor adhesion to the steel substrate. As shown in FIG. 4, the polyurethane with 60% SiC showed a material weight loss of about 20% of the material weight loss of the carbon steel blank.

### Example 6

A commercially available single component polyamide 11 powder, shown in FIG. 4 as “polyamide,” was mixed with 60% SiC powder. The coating with SiC particles had a resulting Shore D hardness between 77 and 79. The mixing with SiC was achieved by mixing the polyamide and 60% SiC Powder by weight. The application was conducted by hot dipping and resulted in an even distribution of SiC particles in coating and uniform DFT, as indicated by visual, optical microscopic and SEM/EDX examinations. The coatings with and without SiC showed excellent adhesion to the steel substrate. As shown in FIG. 4, the polyamide with 60% SiC showed a material weight loss of about 35% of the material weight loss of the carbon steel blank.

### Example 7

A commercially available single component polyether ether ketone (PEEK) coating, shown in FIG. 4 as “PEEK,” was mixed with 60% SiC powder. The coating with SiC particles had a resulting Shore D hardness between 87 and 91. The mixing procedure of the PEEK with SiC was achieved by mixing the liquid coating with SiC. Spray application was conducted using a high volume low pressure (HVLP) spray gun, followed by high temperature drying and curing. The application resulted in even distribution of SiC particles in the coating, uniform DFT and low porosity, as indicated by visual, optical microscopic and SEM/EDX examinations. The coating mixed with SiC showed excellent adhesion to the steel substrate. As shown in FIG. 4, PEEK with 60% SiC showed a material weight loss of about 50% of the material weight loss of the carbon steel blank.

### Example 8

A commercially available single component nitrile rubber base sealant, shown in FIG. 4 as “nitrile,” was mixed with 60% SiC powder. The Shore hardness of this coating could not be measured. The mixing procedure of the nitrile with SiC was achieved by mixing the sealant with SiC. The application was conducted using a putty knife which resulted in an even distribution of SiC particles in the coating film, uniform DFT and low porosity, as indicated by visual, optical microscopic and SEM/EDX examinations. The coating with no SiC showed excellent adhesion to the steel substrate, but loss of adhesion was noted after SiC addition. As shown in FIG. 4, the nitrile with 60% SiC showed a material weight loss of about 80% of the material weight loss of the carbon steel blank.

### Example 9

A commercially available two-component fluoroelastomer coating, shown in FIG. 4 as “FKM,” was mixed with 60% SiC powder. The coating with SiC particles had a resulting Shore D hardness between 68 and 78 and Shore A hardness between 88 and 91. The mixing procedure of the FKM with SiC was performed by mixing parts A and B initially followed by the addition of SiC powder. This coating was applied by two methods: brush and spray applications. The brush application was conducted by using a foam brush and resulted in an even distribution of SiC particles in coating film, uniform DFT and low porosity, as indicated by visual, optical microscopic and SEM/EDX examinations. The brush application with and without SiC showed poor adhesion to the steel substrate. The spray application with and without SiC showed good adhesion to steel substrate, uniform DFT, even distribution of SiC particles. However, high porosity was noted. As shown in FIG. 4, the FKM with 60% SiC showed a material weight loss of 75% of the material weight loss of the carbon steel blank—in half the time of the other tests (i.e., after the first 2 hours). Since the material loss was relatively high after the first 2 hours, no subsequent erosion testing was performed.

From the results of Examples 3-9, it could be noted that certain of the coatings, such as the single component nitrile rubber base sealant, and the two-component fluoroelastomer coating, may provide some erosion mitigation capability, but not to the extent of the remaining coatings. The single component polyether ether ketone (PEEK) also performed marginally better than the base case of carbon steel but did not improve with the addition of SiC.

Several formulations showed less wear than the control carbon steel coupon. The single component polyamide 11 powder exhibited good performance but this performance was degraded with the addition of SiC. It is believed that this coating may be useful for erosion mitigation in certain situations. However, because it is a polyamide, it may be susceptible to chemical degradation if used in hydrocarbon production applications.

The three top performing coatings of these examples included the two-component polyurea coating, the single component nitrile adhesive, and the liquid two-component urethane rubber. All generally showed improved wear resistance with the addition of SiC. In general, the softer more rubbery/elastomeric coatings outperformed their harder polymeric counterparts. However, given the superior chemical stability of nitrile materials to hydrocarbon exposure compared to polyurea and polyurethane, a nitrile coating may be more desirable for such applications.

### ADDITIONAL DESCRIPTION

The following clauses are provided as additional description of various embodiments of the invention.

Embodiment 1. A coating composition for mitigating erosion in coated articles, comprising a polymeric matrix material; and a plurality of hard particles dispersed in the polymeric matrix material wherein the plurality of hard particles have a particle size in a range from 1 to 500 μm, and are present in the polymeric matrix material at a ratio of from 0.5:1 to 20:1 by weight.

Embodiment 2. The coating composition of embodiment 1 wherein the polymeric matrix material is a polymer selected from the group consisting of viscoelastic polymer, elastomer, fluorinated polymer, partially fluorinated polymer, rubber, and combinations thereof.

Embodiment 3. The coating composition of embodiment 2 wherein the elastomer is selected from the group consisting of silicone, polyurethane, and combinations thereof.

Embodiment 4. The coating composition of embodiment 2 wherein the partially fluorinated polymer is polyvinylidene fluoride.

Embodiment 5. The coating composition of embodiment 1 wherein the plurality of hard particles comprise particles selected from the group consisting of sand particles, silicon oxide particles, silicon carbide particles, tungsten carbide particles, steel particles, aluminum oxide particles, titanium carbide particles, diamond particles, carbon nanotubes, and combinations thereof.

Embodiment 6. The coating composition of embodiment 5 wherein the plurality of hard particles have a Mohs hardness greater than 7.

Embodiment 7. A coated article comprising an article having an article surface;

and the coating composition of embodiment 1 applied to the article surface.

Embodiment 8. The coated article of embodiment 7 wherein the article surface comprises a material selected from the group consisting of carbon steel, corrosion resistant alloy, titanium, a plastic, an epoxy-fiber composite and aluminum.

Embodiment 9. A coated article having a coating for mitigating erosion of the coating, comprising: a. an article having an article surface; b. a polymeric layer comprising a polymer bonded to the article surface and bonded to a hard protective layer; and c. the hard protective layer comprising a plurality of hard particles having a particle size in the range from 1 to 500 μm for protecting the polymeric layer from erosion, wherein the plurality of hard particles are present in the polymeric matrix material at a ratio of from 0.5:1 to 20:1 by weight.

Embodiment 10. The coated article of embodiment 9, wherein the polymer comprises a first functionalized end for bonding the polymer to the article surface, wherein the first functionalized end is selected from the group consisting of halides, hydroxyl groups, Si(OR)3, primary or secondary amines, imidazolines, amino heterocycles, and combinations thereof.

Embodiment 11. The coated article of embodiment 9, further comprising an adhesive layer located between the article surface and the polymeric layer comprising epoxy or primer.

Embodiment 12. The coated article of embodiment 9, wherein the polymer comprises a second functionalized end for bonding the polymer to the plurality of hard particles, wherein the second functionalized end is selected from the group consisting of a silane coupling agent, Si(OR)3, and combinations thereof; and wherein multiple chemical bonds are present between the polymer layer and each of the plurality of hard particles.

Embodiment 13. The coated article of embodiment 9, wherein the polymer is selected from the group consisting of viscoelastic polymer, elastomer, fluorinated polymer, partially fluorinated polymer, rubber, and combinations thereof.

Embodiment 14. The coated article of embodiments 7 or 9, wherein the article is a piping component or a pressure containment component.

Embodiment 15. A method for coating an article having an article surface, the method comprising: a. forming a mixture comprising: i. a polymeric matrix material comprising a polymer; and ii. a plurality of hard particles dispersed in the polymeric matrix material wherein the plurality of hard particles has a particle size in the range from 1 to 500 μm, and is present in the polymeric matrix material at a ratio of from 0.5:1 to 20:1 by weight; b. applying the mixture to the article surface thereby forming a coating on the article surface.

Embodiment 16. The method of embodiment 15 wherein the mixture is applied to the article surface by a technique selected from the group consisting of dipping, vapor deposition, melt deposition, spraying, extrusion, powder melting and combinations thereof.

Embodiment 17. The method of embodiment 15, further comprising forming an adhesive layer comprising epoxy or primer on the article surface prior to applying the mixture to the article surface.

Embodiment 18. A method for coating an article having an article surface, the method comprising: a. forming a polymeric layer comprising a polymer on the article surface; and b. forming a hard protective layer comprising a plurality of hard particles having a particle size in the range from 1 to 500 μm bonded to the polymeric layer for protecting the polymeric layer from erosion.

Embodiment 19. The method of embodiment 18, further comprising forming an adhesive layer comprising epoxy or primer on the article surface prior to forming the polymeric layer.

Embodiment 20. The method of embodiment 18 wherein the polymeric layer is formed on the article surface by a technique selected from the group consisting of dipping, vapor deposition, melt deposition, spraying, extrusion, powder melting and combinations thereof.

Embodiment 21. The method of embodiments 15 or 18, wherein the polymer is selected from the group consisting of viscoelastic polymer, elastomer, fluorinated polymer, partially fluorinated polymer, and combinations thereof.

Embodiment 22. The method of embodiments 15 or 18, wherein the hard particles are selected from the group consisting of sand particles, silicon oxide particles, silicon carbide particles, tungsten carbide particles, steel particles, aluminum oxide particles, titanium carbide particles, diamond particles, carbon nanotubes, and combinations thereof.

Embodiment 23. The method of embodiments 15 or 18, wherein the plurality of hard particles have a Mohs hardness equal to or greater than a Mohs hardness of erodent materials anticipated to be encountered by the coating on the article surface.

Embodiment 24. The method of embodiments 15 or 18, wherein the plurality of hard particles have a Mohs hardness greater than 7.

Embodiment 25. The method of embodiments 15 or 18, wherein the polymer contains cross-links joining adjacent polymer chains.

Embodiment 26. The method of embodiment 25, further comprising tuning a degree of cross-linking to achieve a desired property.

Embodiment 27. The method of embodiment 26 wherein the desired property is selected from the group consisting of hardness, swelling, bond strength to an adjacent surface, chemical compatibility with an adjacent surface, chemical compatibility with the plurality of hard particles, a viscoelastic spring property, an environmental property, chemical resistance, impact absorption, viscosity and combinations thereof.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

What is claimed is:

1. A coated pipe to transmit produced fluids in a system configured to recover hydrocarbons from a subterranean formation, wherein the coated pipe comprises:
a pipe component configured to transmit the produced fluids and having an internal surface defining an inner diameter of the pipe component; and
a coating deposited on the internal surface of the pipe component and configured to extend the life of the pipe component by mitigating erosion caused by the produced fluids during transmission thereof, wherein the coating comprises a plurality of particles dispersed in a polymeric matrix material, wherein the plurality of particles has a Mohs hardness equal to or greater than a Mohs hardness of expected erodent materials contained within the produced fluids, and wherein the polymeric matrix material has a hardness between 30 Shore A and 90 Shore D.

2. The coated pipe of claim 1, wherein the plurality of particles has a particle size distribution D₅₀ that is equal to or greater than an expected particle size distribution D₅₀ of the expected erodent materials contained within the produced fluids, the D₅₀ of the plurality of particles being between 10 μm and 500 μm.

3. The coated pipe of claim 1, wherein the plurality of particles has a particle size distribution D₅₀ that is within 50% of an expected particle size distribution D₅₀ of the expected erodent materials contained within the produced fluids, the D₅₀ of the plurality of particles being between 10 μm and 500 μm.

4. The coated pipe of claim 1, wherein the plurality of particles is present in the polymeric matrix material at a ratio of from 0.5:1 by weight particles to polymeric matrix material to 20:1 by weight particles to polymeric matrix material.

5. The coated pipe of claim 1, wherein the coating is physically bonded but not chemically bonded to the internal surface of the pipe component.

6. The coated pipe of claim 1, wherein the coating is chemically bonded to the internal surface of the pipe component.

7. The coated pipe of claim 1, wherein the polymeric matrix material is selected to be more chemically resistant to the produced fluids than a polyolefin matrix material or a polyurethane matrix material.

8. The coated pipe of claim 1, wherein the plurality of particles has a composition, size, and Mohs hardness selected to reduce cutting wear on the coating caused by the produced fluids during transmission thereof, and to transfer impact energy imparted by the expected erodent contained within the produced fluids to the polymeric matrix material.

9. The coated pipe of claim 8, wherein the polymeric matrix material has a composition and Shore hardness selected to dissipate the impact energy imparted by the expected erodent contained within the produced fluids.

10. The coated pipe of claim 1, wherein the plurality of particles and the polymeric matrix material form a first layer of the coating, and wherein the coating comprises a second layer positioned between the first layer and the internal surface of the pipe component, the second layer comprising a polymer material having a greater bonding strength to a material of the interior surface of the pipe component than a bonding strength of the polymeric matrix material of the first layer to the material of the interior surface of the pipe component.

11. The coated pipe of claim 1, wherein:
the polymeric matrix material is a polymer selected from the group consisting of viscoelastic polymer, elastomer, fluorinated polymer, partially fluorinated polymer, rubber, and combinations thereof;
the plurality of particles comprises particles selected from the group consisting of sand particles, silicon oxide particles, silicon carbide particles, tungsten carbide particles, steel particles, aluminum oxide particles, titanium carbide particles, diamond particles, carbon nanotubes, and combinations thereof; and
the internal surface of the pipe comprises a material selected from the group consisting of carbon steel, corrosion resistant alloy, titanium, a plastic, an epoxy-fiber composite and aluminum.

12. The coated pipe of claim 11, wherein the polymer is a nitrile rubber.

13. The coated pipe of claim 1, wherein the polymeric matrix material is chemically resistant to cross-linking due to H₂S amounts of 20 mol % in the produced fluids stream, chemically resistant to hydrolysis due to CO₂ amounts of 30 mol % in the produced fluids stream, and is compatible with additives used in the system to recover hydrocarbons comprising any one or a combination of corrosion inhibitors, hydrate inhibitors, defoamers, and demulsifiers.

14. A method for producing a coated pipe to transmit produced fluids in a system configured to recover hydrocarbons from a subterranean formation, the method comprising:
selecting a plurality of particles based on a composition of the produced fluids, and based on an expected velocity of transmission of the produced fluids within the coated pipe;
selecting a polymeric matrix material based on the composition of the produced fluids, and based on the expected velocity of transmission of the produced fluids within the coated pipe;
dispersing the plurality of particles within the polymeric matrix material to form a mixture; and
applying the mixture to a surface of a pipe or a polymer layer bonded to a surface of the pipe to form a coating on the surface of the pipe.

15. The method of claim 14, wherein selecting the plurality of particles based on the composition of the produced fluids, and based on an expected velocity of transmission of the produced fluids within the coated pipe comprises selecting a size and composition for the plurality of particles based on a respective size and composition of expected erodents present within the produced fluids.

16. The method of claim 14, wherein selecting the polymeric matrix material based on the composition of the produced fluids, and based on the expected velocity of transmission of the produced fluids within the coated pipe comprises selecting the polymeric matrix material based on expected concentrations of hydrogen sulfide and carbon dioxide within the produced fluids.

17. The method of claim 14, wherein applying the mixture to the surface of the pipe or the polymer layer bonded to the surface of the pipe comprises applying the mixture by a technique selected from the group consisting of dipping, vapor deposition, melt deposition, spraying, extrusion, powder melting and combinations thereof.

18. A method for producing a coated pipe to transmit produced fluids in a system configured to recover hydrocarbons from a subterranean formation, the method comprising:
selecting a plurality of particles based on a composition of the produced fluids, and based on an expected velocity of transmission of the produced fluids within the coated pipe;
selecting a polymer based on the composition of the produced fluids, and based on the expected velocity of transmission of the produced fluids within the coated pipe;
forming a polymeric layer comprising the polymer on a surface of a pipe, or on an adhesive layer bonded to the surface of the pipe; and
forming a protective layer comprising the plurality of particles on the polymeric layer.

19. The method of claim 18, further comprising forming the adhesive layer comprising epoxy or primer on the surface prior to forming the polymeric layer.

20. The method of claim 18 wherein the polymeric layer is formed on the surface or the adhesive layer by a technique selected from the group consisting of dipping, vapor deposition, melt deposition, spraying, extrusion, powder melting and combinations thereof.

21. A coated pipe to transmit produced fluids in a system configured to recover hydrocarbons from a subterranean formation, wherein the coated pipe comprises:
a polymeric layer comprising a polymer layered on a surface of a pipe, wherein the polymeric layer has a hardness between 30 Shore A and 90 Shore D; and
a protective layer comprising a plurality of particles, wherein the plurality of particles has a Mohs hardness equal to or greater than a Mohs hardness of expected erodent materials contained within the produced fluids.

22. The coated pipe of claim 21, wherein the plurality of particles has a particle size distribution D₅₀ that is equal to or greater than an expected particle size distribution D₅₀ of the expected erodent materials contained within the produced fluids, the D₅₀ of the plurality of particles being between 10 μm and 500 μm.

23. The coated pipe of claim 21, wherein the polymer comprises a first functionalized end for bonding the polymer to the surface of the pipe, wherein the first functionalized end is selected from the group consisting of halides, hydroxyl groups, Si(OR)₃, primary or secondary amines, imidazolines, amino heterocycles, and combinations thereof.

24. The coated pipe of claim 23, wherein the polymer comprises a second functionalized end for bonding the polymer to the plurality of particles, wherein the second functionalized end is selected from the group consisting of a silane coupling agent, Si(OR)₃, and combinations thereof.

25. The coated pipe of claim 21, further comprising an adhesive layer located between the surface and the polymeric layer, the adhesive layer comprising epoxy or primer.

26. The coated pipe of claim 21, wherein:
the polymer is selected from the group consisting of viscoelastic polymer, elastomer, fluorinated polymer, partially fluorinated polymer, rubber, and combinations thereof;
the plurality of particles comprises particles selected from the group consisting of sand particles, silicon oxide particles, silicon carbide particles, tungsten carbide particles, steel particles, aluminum oxide particles, titanium carbide particles, diamond particles, carbon nanotubes, and combinations thereof; and
the surface of the pipe comprises a material selected from the group consisting of carbon steel, corrosion resistant alloy, titanium, a plastic, an epoxy-fiber composite and aluminum.
